(19) United States
(12) Patent Application Publication
(10) Pub. No.: US 2007/0103521 A1
(43) Pub. Date: May 10, 2007

(54) Ink cartridge for ink-jet printer

(75) Inventor: Shui Kuen Nip, Wanchai (HK)

Correspondence Address: RABIN & Berdo, PC, 1101 14TH STREET, NW, SUITE 500, WASHINGTON, DC, 20005, US

(73) Assignee: POWERFUL WAY LIMITED, North Point (HK)

(21) Appl. No.: 11/594,123

(22) Filed: Nov. 8, 2006

(30) Foreign Application Priority Data
Nov. 9, 2005 (CN) 200520066813.7
Feb. 13, 2006 (CN) 200620003627.3

(51) Int. Cl. B41J 2/175

(52) U.S. Cl. 347/86

(57) ABSTRACT

This invention relates to an ink cartridge for ink-jet printer, comprising mainly an ink storage chamber with two individually assembled parts: an ink supply adjusting valve and an air intake adjusting valve. Ink supply adjusting valve comprises a valve body, front and rear films and a filter mesh and in the valve body at least two ink chambers communicated by means of one or more ink channels are partitioned. The ink inlet of the ink supply adjusting valve is located at the lowest recessed portion of the ink chamber, while the ink outlet is connected to the ink supply port of the ink cartridge. The air intake adjusting valve, constructed of a valve core, a valve base and a valve cover, is connected to the inlet air vent of the ink storage chamber. The working pressure of the valve is adjusted by the resilient valve core.

### BACKGROUND OF THE INVENTION

The present invention relates to an ink supply device and, more particularly, to an ink cartridge for supplying ink to the print head of ink-jet printer.

To solve some problems of ink cartridges with absorption materials about large amount of ink being left in the ink cartridge, high costs and difficulties in recycling the ink cartridge, and environmental pollution, the present applicant filed a Chinese patent application no. 200420091268.2, entitled “Ink Cartridge for Ink-Jet Printer”. This invention discloses an ink supply adjusting valve, by means of which the requirements of simple in construction, reliable in adjusting ink supply pressure, high in product quality and low in cost can be met. However, in this invention, the air vent one-way valve which is made of a resilient valve cap is directly jacketed at the end of the air vent of the cartridge cover. Thus, in order to ensure the air vent one-way valve is working consistently, high precision in assembly and workmanship will be required.

### SUMMARY OF THE INVENTION

It is therefore an object of the present invention to provide an improved construction for the air vent one-way valve in the ink cartridge, that is, reliable combination of several simple components is substituted for a single original part, whereby allowing the air vent one-way valve to be assembled independently as a common part and to serve as an air valve assembly on the inlet air vent (simply called air vent) of the ink cartridge. As a result, a consistent pressure control can be reliably assured at the air vent valve, whereby maintaining a balanced and steady flow of ink supply from the ink cartridge to the printer.

This object of the present invention is achieved through the followings: in an ink cartridge comprising an ink storage chamber formed by a cartridge body and a cartridge cover; an air inlet adjusting valve; and an ink supply adjusting valve consisting of a valve body sealed by films, which is an independently assembled part and is connected to the ink supply port of the ink storage chamber and on the valve body two or more ink chambers are provided, therein one ink chamber is communicated with another one by ink channels and at least one ink chamber is provided with filter mesh and the ink inlet of the ink supply adjusting valve is located at the lowest recessed portion of the ink storage chamber, the improvement is that the air intake adjusting valve consists of a valve core, a valve base and a valve cover, which is an independently assembled part and is connected to the end of the air vent on the cartridge cover, wherein the air vent is sealed by means of the valve core so that the air intake adjusting valve is in a normally closed condition. The valve core is in the form of cap with thin top wall and sealing projection and is made of resilient material, and the edge of the cap is positioned and securely sandwiched between the valve base and the valve cover. The valve base is designed as a three-way opening construction which includes two large axial openings: one at each of the two axial ends and a small channel in a transversal direction, wherein the three openings are communicated in air passage with each other. The valve core is located at the lower large opening of the valve base, wherein the projection relying on the elasticity of the valve core presses against and seals a small air passage joining the valve base lower larger opening and the transversal channel, thereby forming a normally closed valve The lower large opening of the valve base is partitioned into two indirectly communicating chambers: upper chamber and lower chamber, wherein the lower chamber is directly communicated to the ink storage chamber while the upper chamber is also communicated to the ink storage chamber via the foresaid transversal channel. Also, the upper chamber, through a small air passage, is communicated with the upper large opening of the valve base and the air vent of the cartridge cover.

In this improved air vent valve, it is due to the use of dedicated components: the valve base and the valve cover for locating and securely sandwiching the resilient valve core, not only can the requirements for precision assembly be reduced, can the assembly workmanship be simplified but also structurally overcomes the problems such as possible instability of static closing pressure of the valve and excessive fluctuations in magnitude of the negative pressure inside the ink storage chamber resulting from the previous unduly high demand of precision assembly.

### BRIEF DESCRIPTION OF THE DRAWINGS

The foregoing and other features of the present invention will be more readily apparent from the following detailed description and drawings of the illustrative embodiment of the invention in which:

FIG. 1 is a longitudinal sectional view of the ink cartridge of the present invention;

FIG. 2 is an enlarged sectional view of the air intake adjusting valve mounted inside the ink storage chamber of the ink cartridge; and

FIG. 3 is a sectional view of the air intake adjusting valve taken on line A-A in FIG. 2.

### DETAILED DESCRIPTION OF THE PREFERRED EMBODIMENT

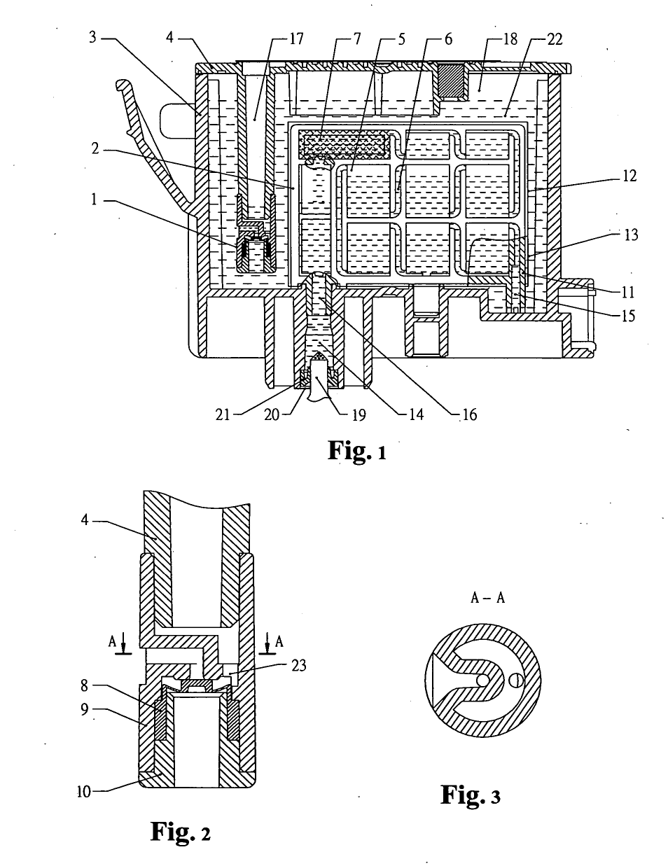

Referring to FIGS. 1-3, an ink cartridge consists of a cartridge body 3, a cartridge cover 4, an ink supply adjusting valve 2, an air intake adjusting valve 1 therein the ink supply adjusting valve 2 is comprised of a valve body 11, filter mesh 7 and front and rear films (12, 13)to form an independently assembled part and is inserted into the ink outlet 14 of the cartridge body 3 in an interference fit manner; two or more through-holes on the valve body 11 together with the front and rear films 12, 12 of the ink supply adjusting valve 2 are constituted as an ink chamber 5, while elongated grooves on the walls of the valve body is constituted as ink channels 6 or referred to as damping orifices; each of the ink chambers 5 is connected in series by dual ink channel, whereby assuring free flowing and continuity of ink movement inside the ink supply adjusting valve; and filter mesh 7 is mounted on at least one of the ink chambers 5. An ink inlet 15 with elongated small caliber structure and an ink outlet 16 with larger caliber are provided at the lower portion of the ink supply adjusting valve 2 therein the ink inlet 15 is extended into the recessed portion on the bottom of ink storage chamber 18, whereby fully extracting the ink 21 inside the ink storage chamber 18. The ink outlet 16 is communicated in ink fluid with the ink supply port 14 of the ink cartridge. The foregoing structure is able to control suitably and efficiently the flow and pressure of the ink 21 inside the ink supply adjusting valve 2.

The air intake adjusting valve 1 is an independently assembled part which consists of a valve core 8, a valve base 9 and a valve cover 10. An opening is respectively provided at each of the two axial ends of the cylindrical shaped valve base 9 and a small channel is transversally provided, which are communicated with each other to form a three-way-opening structure. The upper end large opening of the valve base 9 is inserted into the end of the air vent of the cartridge cover 4 in an interference fit manner. The valve core 8 is provided in the lower end large opening of the valve base 9 which is in a cylindrical cap form and is made of resilient material such as silicon rubber and the top surface of which has a projection. The top surface which has a large surface area and a small thickness is the portion that has a relatively high elasticity in the valve core 8. The projection which lies in the centre of the top surface of the valve core 8 has a small cross-sectional area, relies on the elastic properties of the top wall of the valve core 8 to press it against and seal the air passage from the lower large opening to the transversal channel of the valve base 9 in order to form a normally closed valve that can be freely opened or closed. The cylindical cap edge which is larger in thickness and smaller in elasticity is for the purpose of positioning and sealing, wherein the upper shoulder and the lower end face are respectively in close contact with the inside stepped end face in the valve base 9 and stepped axial end face of the valve cover 10 so that the valve core 8 is not able to be axially drifted in the valve base 9. The lower large opening within the valve base 9 is partitioned by the valve core 8 into two indirectly communicating chambers: upper chamber and lower chamber, therein the lower chamber is directly communicated with the ink storage chamber 18 and the upper chamber is also communicated with the ink storage chamber 18 via the foresaid transversal channel and the upper chamber after passing through a small air passage 23 is also communicated with the upper end large opening of the valve base 9 and the air vent on the cartridge cover 4. The outside air entered into the upper chamber from the air vent on the cartridge cover 4 may get into the transversal channel of the valve base 9 via the upper end surface of the projection on the valve core 8 only when the air intake adjusting valve is opened. Then, the air can enter into the ink storage chamber 18 and the lower chamber. Therefore a normally closed air intake adjusting valve is formed on the air vent of the cartridge cover 4.

As shown in FIG. 1, the ink cartridge has been installed to the printer. At this moment, ink outlet needle 19 of the print head punctures the sealing film 20 and then enters into the sealing ring 21 of the ink supply port 14 of the ink cartridge. While the print head is in non-operation mode, the air intake adjusting valve 1 is in normally closed condition. The forces, internal and external of the ink cartridge, acting on the valve are in a state of static equilibrium. The pressure inside the ink storage chamber 18 is slightly less than the outside atmospheric pressure, thus maintaining the ink storage chamber 18 under a suitable negative pressure. The ink 22 is then under a static equilibrium and so will not leak through the ink outlet needle 19 of the print head.

When the print head is in operation, a low pressure area in the ink supply port 14 of the ink cartridge is, first of all, formed due to the suction from the print head, and then low pressure area rapidly and orderly spreads to the ink supply adjusting valve 2 and the ink storage chamber 18. The two films 12, 13 which are symmetrically welded on the front and rear surfaces of the ink supply adjusting valve 2 simultaneously become inwardly concave. As a result, the inside volume of the ink supply adjusting valve 2 decreases and the pressure increases, whereby allowing part of the ink inside the ink supply adjusting valve 2 to flow to the ink supply port 14 of the ink cartridge. Therefore, at this moment the ink flow is suitably increased. When the low pressure area spreads to the ink storage chamber 18, the air intake adjusting valve 1 will be out of such a static force equilibrium. As a result, the valve is opened as higher atmospheric pressure outside the air intake adjusting valve 1 overcomes the resistance of the resilient force coming from the bending deformation of the valve core top wall.

Thus, after the valve is opened, the outside air enters into the ink storage chamber 18 via the upper chamber of the valve base 9 and the upper end surface of the projection of the valve core 8. At the same time, the closing pressure of the air intake adjusting valve 1 drops down to zero. The degree of bending deformation on the valve core 8 top wall increases with the increase in negative pressure in the ink storage chamber 18 while the resilient force coming from the top wall of the valve core 8 also increases with the degree of the bending deformation. Due to that direction of the resilient force is opposite to that of deformation, the resilient force always resists the increasing degree of the deformation, that is, resisting the valve from being opened. As a result, the valve is in a state of dynamic equilibrium so that the pressure inside the ink storage chamber 18 remains always slightly higher than that before the valve is opened, but is lower than the outside atmospheric pressure. Thus in that way, the air intake adjusting valve 1 dynamically adjusts the pressure inside the ink storage chamber 18 to a steady value. Thus, after the valve is opened, the ink pressure inside the ink storage chamber 18 will rise suitably so that the ink 22 inside the ink cartridge flows from the ink storage chamber 18 to the ink supply adjusting valve 2, then to the ink supply port 14 of the ink cartridge, and finally to enter into the ink outlet needle 19 of the print head.

The ink supply adjusting valve 2 with varying sections of ink flow channels further suitably adjusts the flow volume and the pressure of the ink flowing through it.

When the print head stops operation, the inwardly concave phenomenon of the front and rear films 12, 13 on the ink supply adjusting valve disappears, becomes relaxed and returns to their original positions due to the disappearance of suction. Consequently, the volume within the ink supply adjusting valve 2 increases and the pressure decreases. As a result, the ink within the ink supply adjusting valve 2 stops flowing out while small amount of ink outside the ink supply adjusting valve 2 flows from the ink inlet 15 and the ink outlet 16 respectively into the valve, until the ink pressure inside and outside the ink supply adjusting valve 2 is in equilibrium and a suitable amount of the ink is stored therein. Meanwhile, the air intake adjusting valve 1 is back to normally closed state and the ink cartridge returns to its state of slightly negative pressure. A new static equilibrium of ink is then established.

The static and dynamic characteristics of the air intake adjusting valve 1 will be further described as follows by means of the analysis of forces acting on the valve core 8 of the air intake adjusting valve 1.

According to mechanical equilibrium equations, when the ink cartridge is not in operation, the sum of four forces, namely the closing force F₁ of the projection on the top wall of the valve core 8 (corresponding to the supporting force exerting on the projection from the end face of the valve); the force P₀S₁ due to the external atmospheric pressure (P₀) exerting on the external face (surface area S₁) of the top wall of the valve core 8; the force P₁S₂ exerting on the upper end face (surface area S₂ ) of the central projection of the valve core 8; and the weight G due to gravity on the top wall and the projection of the valve core 8 is equal to sum of three forces, namely the resilient force KΔ created by the bending deformation Δ of the top wall of the valve core 8 (corresponding to axial restraining force on the valve core 8 exerted by the valve base 9 and the valve cover 10; K is a coefficient of elasticity, which may be considered as a constant), the force P₁ (S₁+S₂) exerting on the internal face (surface area S₁+S₂) of the top wall of the valve core 8 and the surface tension force F2 due to the possible existence of ink fluid in the gaps of the valve, that is:
F₁+P₀S₁+P₁S₂+G=KΔ+P₁(S₁+S₂)+F₂

Since the weight G due to gravity and the surface tension force F2 are relatively small, they can be ignored. Thus, the above equation can be rewritten as:
P₀−P₁=(KΔ−F₁)/S₁
From the equation above, we can see that when P₀−P₁=0, KΔ−F₁=0, that is, when the pressure P₁ inside the ink storage chamber 18 becomes very close to the atmospheric pressure P₀, the closing force F₁ of the projection of the valve core 8 becomes very close to the elastic force KΔ arisen from the bending deformation of the top wall of the valve core 8. This is just the case when the ink cartridge is not in operation. Therefore, when the bending deformation Δ of the top wall of the valve core 8 is larger, F₁ also is larger. As a result, the projection of the valve core can be reliably and steadily closed on the valve opening.

When the ink cartridge is in operation, the air intake adjusting valve 1 is opened, that is, the valve core 8 is out of contact with the valve base 9 (Fᵢ=0). Under this circumstance, the above equation can be rewritten as:
P₀−P₁=KΔ/S₁

The above equation shows that at this moment the negative pressure inside the ink storage chamber 18 is associated with the bending deformation Δ and the surface area S₁ of the valve core top surface, in particular, it is directly proportional to former and is inversely proportional to the latter. Since the top surface area S₁ of the valve core in this construction is large, the bending deformation KΔ of the valve core top surface can be made larger if the negative pressure inside the ink storage chamber 18 is required to remain substantially unchanged. The elasticity of the valve core having the higher degree of deformation is able to be kept stable during operation so that the phenomena, such as skewness, relaxation, excessive random variations of elasticity and the like, will not occur. Therefore, the air intake adjusting valve in accordance with the present invention is able to be reliably closed when the ink cartridge is not in operation while the negative pressure inside the ink storage chamber is able to be stably and effectivly adjusted when the ink cartridge is in operation.

As mentioned above, in the ink cartridge of the present invention, the ink flow and ink pressure are adjusted by means of specifically structured ink flow channels inside the ink supply adjusting valve, in which fine adjustment of the ink flow is carried out through the function of the films similar to the relaxation—contraction deformation of a porous foam material, and the magnitude of negative pressure variations inside the ink chamber controlled by means of the normally closed air intake adjusting valve, thus adjusting the flow and pressure of the ink fluid flowing toward the ink outlet needle of the print head in a timely and suitably manner.

Besides, when the printer indicates that the ink inside the ink cartridge is depleted, the ink cartridge can be removed from the printer and then refilled with ink through the ink filling port. Once completed, the ink cartridge can be re-installed to the printer and may continue to be used, whereby accomplishing the recycling use and the extension of the service life of the ink cartridge according to the present invention.

What is claimed is:

1. In an ink cartridge for ink-jet printer comprising an ink storage chamber, an ink supply adjusting valve and an air intake adjusting valve therein the said ink supply adjusting valve consists of a valve body sealed by films to form an independently assembled part and to be connected to the ink supply port of the said ink storage chamber, and on the said valve body two or more ink chambers are provided while ink channels are provided to connect the adjacent ink chambers, in at least one of the said ink chambers a filter mesh is provided; an ink inlet of the said ink supply adjusting valve is located at the lowest recessed portion on the bottom of the said ink storage chamber; and the said air intake adjusting valve is an normally closed one, the improvement is that the said air intake adjusting valve is constructed of a rigid valve base located at the end of the inlet air vent and a valve core assembled inside the said valve base therein the said valve core is made of resilient material and is in the form of cap with a thin top wall and a projection, by means of which the said inlet air vent is sealed so that the said air intake adjusting valve is in a normally closed condition.

2. The ink cartridge for ink-jet printer as recited in claim 1 wherein the said valve base of the said air intake adjusting valve is a three-way-opening structure in which the two axial end openings and a transversal channel thereof are communicated with each other; the said valve core is fixed by means of the valve cover, to seal the air passage through which the lower end axial opening is communicated with the transversal channel, and to partition the lower end axial opening into two upper/lower chambers which are not communicated with each other. The said lower chamber is directly communicated with the said ink storage chamber; whereas the said upper chamber is communicated with the said ink storage chamber via the valve and in addition communicated with the outside via a small air passage and the said inlet air vent.
